(19) United States
(12) Patent Application Publication
(10) Pub. No.: US 2012/0131817 A1
(43) Pub. Date: May 31, 2012

(54) CUSTOM-FIT INSOLE FOR FOOTWEAR AND RELATED METHOD OF MANUFACTURE

(76) Inventor: Eero KAAKKOLA, Helsinki (FI)

(21) Appl. No.: 12/956,511

(22) Filed: Nov. 30, 2010

(51) Int. Cl. A43B 13/38; B32B 7/08; B32B 3/30

(52) U.S. Cl. 36/44; 428/156; 156/93

(57) ABSTRACT

An insole suitable for use with footwear. A body has at least one material layer and includes at least one heat-sensitive support element including thermoplastic material. The heat-sensitive support element is embedded in or joined with body to enable shaping at least part of the insole when heated and hardening by cooling. The heat-sensitive support element includes a plurality of hollows facing a direction substantially opposite a predetermined top side of the insole intended to receive a foot of a user. A corresponding method.

### FIELD OF THE INVENTION

Generally the present invention pertains to footwear. In particular the invention concerns custom-fit insoles.

### BACKGROUND OF THE INVENTION

Classically insoles placed on the midsole of footwear such as shoes have been applied to capture dirt and moisture from the foot, provide cushioning (shock absorption) thereto and/or achieve optimal fit of the foot relative to the footwear amongst potential other purposes. Different use scenarios, e.g. various sport disciplines, have required scenario-specific customization of the insole and footwear design and related materials in view of desired support, comfort, water resistance, size, weight, and durability, for example. In addition, as human feet considerably vary in size and other features between a plurality of subjects, and even between left and right foot of the same subject, custom-made, personalized insoles and shoes have been around for some time already.

Traditionally, custom-fit shoes or insoles have been manufactured by specialists such as shoemakers or podiatrists, respectively. Measuring a subject person's feet, designing the associated molds and manufacturing the personalized insoles therewith has been a lengthy process taking several days or even weeks, not to mention processes leading to fully custom-made shoes. Obviously the resulting price of these kinds of top-end products has been relatively high due to e.g. the variety of different process steps and the amount of handwork required.

More recently, easier and quicker tailoring options for footwear have been developed utilizing a standard-shaped, typically substantially flat insole preforms as a starting point for in situ instant or low-delay customization via shaping and optionally cutting.

For example, in certain solutions different chemically or thermally curable chemicals have been included in an unshaped, still plastic, insole preform followed by placing a subject person's foot in contact with the preform to make an impression thereon while initiating the curing process. As a result, a custom-made insole has been ultimately obtained, having a shape following the contour of the subject person's sole.

Some other solutions have particularly utilized thermoplastic material as an ingredient of an insole. Upon heating an insole preform provided with thermoplastic material over a predetermined temperature, a so-called glass transition temperature, the thermoplastic material turns formable and plastic thus enabling manual shaping of the then flexible and elastic insole according to the subject person's foot such that potential foot problems like overpronation or oversupination are advantageously also addressed by the supporting and correcting effect of the modified insole shapes. Letting the shaped insole to cool down below the aforesaid temperature hardens the material back to solid yet preserving the newly-gained custom shape.

US2008010856 discloses one example of the latter-type custom-fit insoles, wherein thermoplastics are utilized. Insole preforms comprising a layer of thermoplastic material are provided to retail stores for real-time customization by a clerk in view of the personal properties of each client. For example, the client's foot and the customized insole may be adjusted such that the plantar arch settles to a normal high position. The supply chain from an insole manufacturer to the end client is thus shortened and the insoles kept affordable.

Even the admittedly, in many ways splendid contemporary formable individualized insoles, such as the aforementioned insoles comprising a layer of thermoplastic material, still bear a number of flaws or at least practical imperfections in terms of the properties of the shaped and user-specifically tailored end product not forgetting the manufacturing and shaping phases thereof. Namely, it has been noticed that in connection with heavy users and/or hard use, a shaped but thin thermoplastic layer included in an insole does not necessarily provide sufficient support to the user's foot. However, increasing the thickness of the thermoplastic layer for enhanced support makes shaping thereof trickier, if not impossible, and possibly causes continuous discomfort as the user may then feel the presence of the boosted layer beneath the insole top portion and consider it annoyingly hard. The weight of the insole and thus the associated footwear evidently increases and more production material is required for manufacturing it, which fights against one evident basic principle of insole and generally footwear design, i.e. lightness, and causes additional pressure on the price of the insole.

### SUMMARY OF THE INVENTION

It shall be noted that this summary is generally provided to introduce a selection of concepts that are further described below in the detailed description. However, this summary is not intended to specifically identify most important or, in particular, essential features of the claimed subject matter and thus limit the claimed subject matter's scope.

Accordingly, it is an object to alleviate one or more defects associated with prior solutions. This and other objects may be achieved with embodiments of the invention which may take the form of an insole, a heat-sensitive support element for use with an insole, or a related method of manufacture.

In one aspect, an insole suitable for use with footwear, includes a body having one or more material layers and provided with at least one heat-sensitive support element, such as a layer or piece, comprising thermoplastic material, the heat-sensitive support element being embedded in or joined with body to enable shaping at least part of the insole when heated and hardening by cooling, the heat-sensitive support element comprising a plurality of hollows facing a direction substantially opposite the predetermined top side of the insole intended to receive a user's foot.

Shaping may be performed to correct the foot posture with proper support, for example, and/or to generally match the shape of the insole better with the target user's foot's shapes to provide additional comfort and/or support.

In some embodiments, the hollows may include a plurality of at least piece-wise parallel elements such as grooves. A number of substantially longitudinal and/or transverse hollows may be arranged relative to the insole, for example. The hollows may be arranged in row, matrix (rows and transverse columns), and/or some other configuration. Through-holes and similar may be at least mostly omitted to avoid the possible annoyance by the user arising from feeling the resulting indented surface structure through the insole top surface. Instead, e.g. blind-holes may be preferred. The hollows may be independent and separate from each other and/or they may be connected with reference to e.g. the aforesaid matrix form wherein the rows and columns may obviously have joints, i.e. common portions. A hollow or a plurality of hollows may define different patterns and forms, which may include straight, curved and/or various geometric shapes in the thermoplastic substrate material of the heat-sensitive support element.

In another aspect, a method for manufacturing an insole includes obtaining at least one heat-sensitive support element comprising thermoplastic material and being configured with a plurality of hollows on a predetermined bottom side of the element, and providing a body of one or more material layers with the heat-sensitive support element to enable shaping at least part of the insole when heated and hardening by cooling.

In a further aspect, a heat-sensitive support element for an insole of footwear includes thermoplastic material to enable shaping at least part of the insole when heated and hardening by cooling, the heat-sensitive support element further including a number of hollows on a predetermined bottom side of the element configured to substantially face, when in use, the insole bottom.

The utility of embodiments of the present invention and especially of the described use of hollows in the integrated support element follows from a plurality of issues depending on each particular embodiment thereof. The obtained insole may be light and thin, yet stiff enough in relevant portions. Even the insoles with raised maximum thickness due to a heavy user and/or heavy use inducing heavy load, may remain relatively light, thin (on average) and thus comfortable. Also re-shaping the insole may remain somewhat effortless when heated due to added flexibility, thanks to the hollows. It may further heat up and cool down rapidly. The shaped insole may effectively support the user's foot, correct the foot posture and reduce unnecessary shock load to the foot, knees, and back, and further minimize the related wear and pain e.g. in joints. The insole may be made affordably and affordable. For instance, thermoplastic material may be saved due to the presence of hollows therein.

The expression “a number of” refers herein to any positive integer starting from one (1), e.g. to one, two, or three.

The expression “a plurality of” refers herein to any positive integer starting from two (2), e.g. to two, three, or four.

The expression “to comprise” is applied herein as an open limitation that neither requires nor excludes the existence of also unrecited features.

The terms “a” and “an” do not denote a limitation of quantity, but denote the presence of at least one of the referenced item.

The term “thermoplastic material” refers herein to material that softens on being heated above a predetermined temperature and hardens again when cooled back. Thus the softening is substantially reversible with thermoplastic materials in contrast to e.g. thermosets that harden basically permanently when heated enough.

The term “hollow” refers herein to a hole, notch, dent, cavity, excavation, recession, depression, groove, or any similar form. The dimensions or the shape of the hollow is not restricted to any particular embodiment, if not stated otherwise.

Different embodiments of the present invention are disclosed in the dependent claims.

### BRIEF DESCRIPTION OF THE RELATED DRAWINGS

Next the invention is described in more detail with reference to the appended drawings in which

FIG. 1a illustrates, via a cutaway view, an embodiment of an insole according to the present invention.

FIG. 1b is a perspective cutaway representation of the embodiment of FIG. 1a.

FIG. 1c is another cutaway and substantially also cross-sectional view of the insole internals along the transverse line A-A′.

FIG. 2a illustrates an embodiment of a heat-sensitive support element according to the present invention.

FIG. 2b is a cutaway and substantially also cross-sectional view of the heat-sensitive support element along the transverse line B-B′ of FIG. 2a.

FIG. 2c is a longitudinal side view of an embodiment of the support element.

FIG. 2d illustrates the bottom surface of an embodiment of the heat-sensitive support element.

FIG. 3 is a flow diagram disclosing an embodiment of a method in accordance with the present invention.

FIG. 4a illustrates an embodiment of an insole in accordance with the present invention after customization.

FIG. 4b illustrates the embodiment of FIG. 4a from another angle.

### DETAILED DESCRIPTION

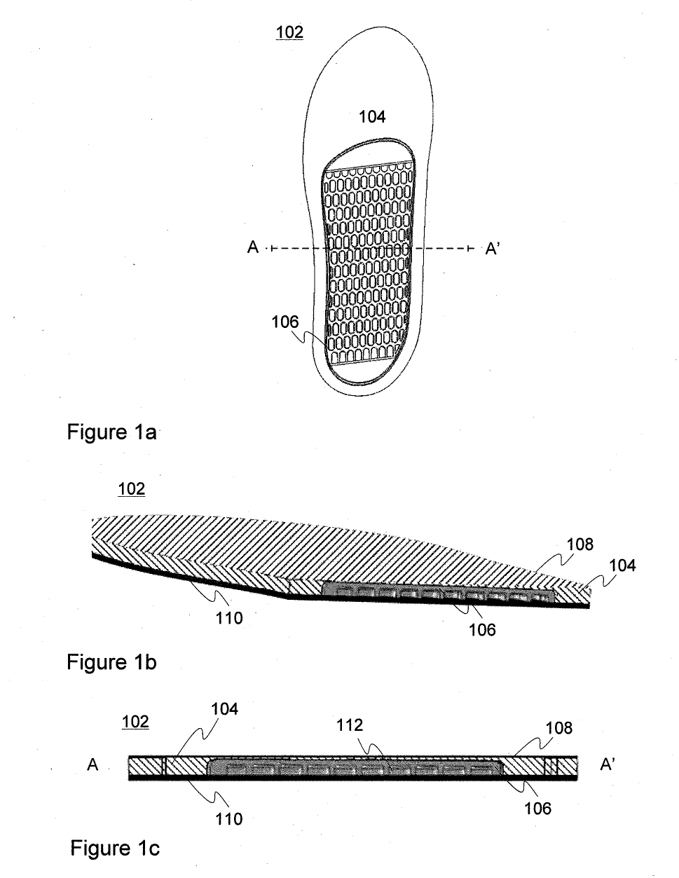

FIG. 1 illustrates a planar, top view of an embodiment of an elongated insole 102 according to the present invention. It comprises a body 104 of one or more material layers, such as (soft) foam layers and/or other layers, and at least one heat-sensitive support element 106, such as a layer or piece incorporating thermoplastic material, comprising a number of hollows facing a direction substantially opposite the predetermined top side of the insole receiving a user's foot, i.e. the number of hollows substantially facing the ground and away from the user's sole when the insole is in use. In some embodiments the insole 102 may be particularly configured in view of e.g. dimensions so as to receive the user's foot (there may be e.g. a sock thereon) including both the toes and the sole. In alternative embodiments, insoles designed to receive only a portion of the foot such as the sole or a part thereof may be constructed.

In the figure, a piece has been cut out from the insole surface to illustrate the underlying support element 106 provided with the hollows. The hollows, although preferably facing the insole bottom, have been also shown in the figure for illustrative purposes. In some embodiments, the support element 106 may be optically substantially trans-parent or translucent in which case the contours of the hollow structures may also in reality be viewable from above the element 106.

In some embodiments, a plurality of heat-sensitive support elements 106 may be utilized in the same insole. The elements 106 may differ in properties such as material, thickness, shape, the configuration of hollows, etc. depending on the location and thus desired characteristics of the elements, for instance.

When properly shaped according to the user's foot, the insole 102 may nicely conform to the underside of at least portion thereof. The insole 102 may be located underneath the foot in a shoe or other footwear such as a (ski) boot.

FIG. 1b represents one possible perspective cutaway illustration of the embodiment of FIG. 1a. The visualized insole 102 is obviously a preform, i.e. it still bears a substantially default, i.e. flat and/or non-customized basic shape, which may be preferred for storing the insole 102 with minimum space requirement prior to sale or use instant upon which it is then subjected to heat-enabled user-specific shaping and optional further tailoring potentially including cutting of the excessive (edge) material in view of different footwear and feet, for example.

The body 104 defines, in the illustrated embodiment, a middle layer of the insole 102 and extends substantially over the insole length. In addition to the support element 106, further material layers and functional and/or physical elements (pieces) such as a bottom layer 110, optionally comprising fabric or rubber, configured to contact the footwear, and/or at least one top layer 108 defined by e.g. predetermined fabric, may be included in the insole 106, however being not compulsory. Yet, these further layers and elements may be considered to belong to the body 104 or, due to having e.g. some specific other function like the support element 106, be thus at least logically seen to remain as separate therefrom and/or be really physically still separable.

The body 104 may be substantially planar or contain a number of protrusions, recessions, and/or other forms. The top side thereof may be made at least partly complementary to an estimated shape of a user's sole. It may include a contoured surface and e.g. concave form(s) for the purpose. The body 104 may be substantially solid or contain e.g. a number of holes. The body 104 and the remaining other physical elements such as the support element 106 connected thereto thus advantageously form an aggregate, composite entity, although in some embodiments one or more physical elements thereof may be removably connected to enable subsequent cleaning, replacement or other procedure requiring removal.

Two or more material layers or elements may be generally joined together utilizing gluing, laminating, stitching, and/or moulding, for example. Among other options hot glue (hot melt adhesive) may be applied. Also mechanical coupling via e.g. friction-based fastening arrangements such as a projection and a recess, the two optionally being complementary in shape and configured to engage each other, and/or hook-and-loop (e.g. Velcro™) or other type of fasteners may be applied. These latter options facilitate connecting elements together removably. Fastening elements may itself be attached to the corresponding substrate materials by gluing, for example.

One or more functional and/or physical elements may be provided to the insole including at least one element selected from the group consisting of a cushioning element, moisture-permeable element, moisture-repellent element, moisture absorbing element, moisture-controlling element, anti-bacteria element, anti-corn element (e.g. cushion, recess and/or partition (or other guiding element) for the purpose), anti-fungus element, gel element, barrier element, odor-free element, arch support element, heel cup, stitching, washable element, anti-slippery element, and the aforesaid heat-sensitive (thermoplastic) element. The barrier element may prevent contact and/or material flow between two material layers such as a gel layer and adjacent layer, for example. A number of predetermined shapes, materials and/or treatments thereof (heat, chemical, etc.) may be generally applied to implement various preferred functionalities. An element may be typically formed from a number of material layers and/or physical elements provided to the insole structure 102.

Regarding the applicable materials in general, the insole 102, such as the body 104 thereof, may include at least one material, such as synthetic foam material, selected from the group consisting of EVA (Ethylene Vinyl Acetate), PU (Polyurethane), PE (Polyethylene), and polyester. Other suitable materials may be utilized as well. As mentioned hereinbefore, the body 104 may be a composite of a plurality of materials. The insole 102 is a composite of at least the basic body material and the optionally removably integrated support element 106 by default.

The support element 106 may include at least one thermoplastic material selected from the group consisting of ABS (acrylonitrile butadiene styrene), PVC (polyvinyl chloride), A-PET (Amorphous polyester terephthalate) and PETG (polyethylene terephthalate Glycol). Other suitable materials may be applied. The support element 106 may also be a composite of a plurality of materials.

FIG. 1c is another cutaway, substantially also cross-sectional, view of the insole internals along the transverse line A-A′. In this figure, the hollows 112 defined by the support element 106 are clearly visible. The hollows 112 have substantially rectangular, slightly rounded cross-section, which may imply e.g. substantially rectangular cuboid as the 3D shape of each hollow as defined by the element 106, but in other embodiments a number of other shapes may be additionally or alternatively exploited. For example, substantially half-ellipsoidal shape could be applied.

In various embodiments, preferably the shape, dimensions, densities and/or patterns of the hollows are selected such that desired savings in the use of the thermoplastic material(s), increase in the plastic state shapeability in contrast to conventional flat face support element, and sufficient structural strength and/or rigidity are achieved. Various existing structural engineering design rules and applications may be utilized for determining suitable hollow shapes etc. so that the predetermined design parameters such as tensile, compressive, and/or torsional (shear) strengths are fulfilled regarding related insole portions and locations. In many cases, round, regular, and/or symmetrical shapes may provide the desired results.

In some embodiments, the hollows 112 may form a cellular or matrix pattern structure on the support element 106. This may be done to achieve the desired design objectives such as lightness, strength, rigidity and/or thickness (average or max). The hollows may remain unfilled. Alternatively, one or more hollows could be at least partially filled with predetermined material, which might be different in properties in contrast to the thermoplastic material of the support element 106, such as softer and more flexible foam material and/or material having specific other characteristics. The filling material may be provided to the hollows separately and/or via an underlying layer comprising e.g. protrusions reaching out to the hollows.

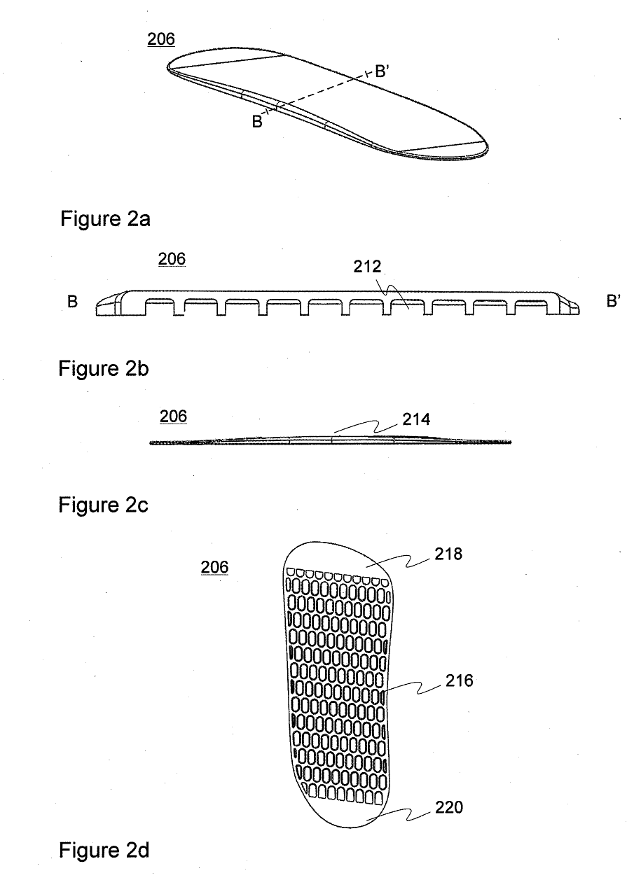

FIG. 2a illustrates the general outline of an embodiment of a heat-sensitive support element 206 according to the present invention. Such support element 206 shown in a preform condition (i.e. substantially flat and/or non-customized), could be applied in connection with the insole of FIG. 1a, for example. The shape of the heat-sensitive support element 206 may vary depending on the embodiment. For example, it may generally follow the shapes of the overall insole or the body thereof, optionally with smaller dimensions such as length and/or width. Alternatively, the element 206 may bear different shape, e.g. substantially elliptical or circular shape. The support element 206 may be dimensioned and positioned so as to extend across the length of the insole or just a number of portions thereof, from the heel area till the toe area, for example. In some embodiments, a plurality of thermoplastic support elements may be applied in a single insole as mentioned hereinearlier. Each support element may be configured to provide dedicated foot support in its predetermined location.

FIG. 2b is a cutaway and substantially also cross-sectional view of the heat-sensitive support element along the transverse line B-B′ of FIG. 2a. Cross-sections of the hollows 212 are visible in this figure. Some predetermined areas such as border areas (front/toe area, side area(s) and/or back/heel area) may at least partially lack the hollows, or their density, size, and/or depth may be smaller in contrast to other areas. In other words, some portions of the element 206 may be configured to contain a number of predetermined hollows and the rest be left without.

FIG. 2c is a longitudinal side view of an embodiment of the support element.

As shown in the figure, the thickness of the element 206 may vary and be thus uneven. Accordingly, the target insole including the element 206 may also vary in thickness in case the variance in the thickness of the element 206 is not compensated by complementary design of a number of other elements of the insole such as the body. The thickness may be varied in longitudinal and/or transverse direction of the insole. For instance, a number of predetermined portions such as the central portion 214 of the element 206 may be made thicker than remaining areas such as the border areas, e.g. toe and/or heel areas, to provide additional rigidity and foot support in desired locations only, such as the estimated location of a predetermined arch of a user's sole, e.g. the plantar arch. Also the longitudinal side edges may be made thinner. Yet, the shaped element 206 may be better able to correct wrong plantar arch and/or transverse arch postures as the more rigid and stronger thicker portions can be disposed at least in the associated more critical areas of the insole. Alternatively, the element 206 may be, in preform state, substantially planar and of substantially equal thickness.

In some embodiments, the maximum thickness of the support element 206 and/or the overall insole may preferably be about 5 mm or less, more preferably about 3 mm or less, and most preferably about 1.5 mm or less. The use of hollows lightens the insole in contrast to solid counterpart and makes the element 206 more flexible and shapeable even in the case of embodiments with elevated maximum thickness.

Preferably the edge thickness of the support element 206 and/or the overall insole may be about 1.5 mm or less, more preferably about 1 mm or less, and most preferably about 0.5 mm or less.

Generally thinner structures reduce the total weight while adding to the shapeability and wearing comfort. By various embodiments of the present invention, certain areas of the insole may be thus made thicker for the purposes of increased rigidity and support, for example, while substantially maintaining the above advantageous characteristics due to e.g. clever configuration of hollows (shaping, dimensioning, patterning) based on the applied structural engineering design guidelines. The use of hollows allows more flexible location-dependent adjustment of the insole properties.

In some embodiments, the depth of a number of hollows may be about 20%, 30%, 40%, 50%, 60%, 70%, 80%, or 90% of the average or maximum thickness of the element 206. The above figures may alternatively indicate lower or higher limits of the corresponding ranges for preferred hollow depth. The depth of the hollows may vary and be location-dependent relative to the element 206. For example, on areas with reduced need for maximal stiffness and/or rigidity, the hollows may be at least relatively deeper than on the other areas. Alternatively or additionally, on areas with higher maximum thickness (to provide maximum foot support, for example) the hollows may be made deeper to reduce the corresponding average thickness and balance out the weight and comfort aspects otherwise easily weakened by the elevated maximum thickness.

FIG. 2d illustrates the bottom surface of an embodiment of the heat-sensitive support element. A cellular pattern structure 216 as defined by the hollows and walls between them is extending from the heel area to the toe area such that the both ends 218, 220 of the element 206 remain hollow-free. Such portions may also be thinner than the rest of the element 206. In some embodiments, at least a part of the heel portion and/or the toe portion may be substantially hollow-free and optionally of thinner construction than the central portion with increased thickness for additional foot support.

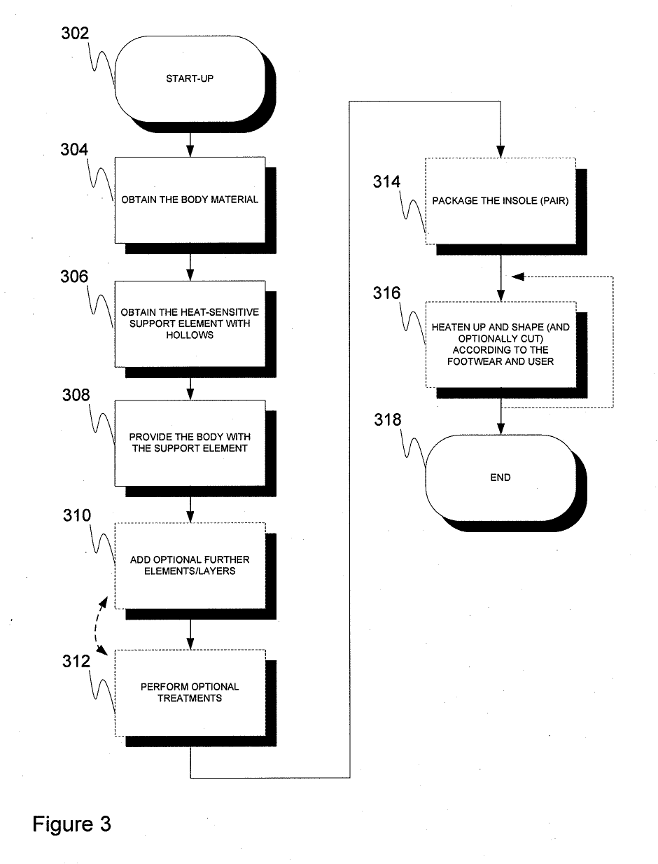

FIG. 3 is a flow diagram disclosing an embodiment of a method in accordance with the present invention. Optional items are indicated with broken lines in the figure.

At start-up 302, the necessary gear such as machining gear, a molding machine and/or a hot glue provision apparatus, e.g. a hot glue gun, may be obtained and configured.

At 304, the body material(s) such as predetermined foam is obtained. Ready-made material pieces may be acquired from a supplier or the material may be in-house manufactured. Suitable moulding process may be applied. The body material may be arranged such as cut to a predetermined preform shape and size at this point or later during the process depending on the embodiment.

At 306, at least one heat-sensitive support element comprising thermoplastic material is obtained for each insole to be manufactured. Again, ready-made pieces may be acquired from a supplier or they may be in-house manufactured. The support element may be manufactured by injection moulding, for instance.

The general shape and the hollows may be formed by the mold. Alternatively or additionally, suitable machining technique(s) such as milling, carving, drilling, boring, planning and shaping may be applied for either or both the purposes. Chemical method(s) such as etching may be utilized.

At 308, the body is provided with the at least one heat-sensitive support element. The body may contain a number of material layers some of which may cover the at least one support element and/or remain under it. For example, the body may include a foam layer covered by a fabric layer with desired properties such as moisture-repellency or permeability.

In some embodiments, the at least one support element optionally provided with further element(s) such as the insole bottom layer-forming element may be utilized as an insert in a moulding process, such as injection moulding process, during which additional material such as body material(s) is provided thereon during a number of moulding rounds. Thus, the body may be substantially simultaneously formed and joined with the at least one support element. For example, the at least one support element may be overmoulded with the body material(s). The body may at least partially embed the at least one support element. In some embodiments, the body may at least partially cover the at least one support element.

As an alternative to moulding, a potentially ready-formed body, optionally comprising a recess for accommodating at least part of the at least one support element, may be attached to the at least one support element or an aggregate of the at least one support element and further element(s) such as cushioning element(s) and/or material layer(s) by gluing or laminating, for example.

At 310, optionally further material layers and/or elements, such as the bottom layer of the insole, such as a fabric layer with desired properties such as friction, may be provided to the insole by gluing or laminating, for example. The bottom layer and the body may be configured to jointly encapsulate the at least one support element.

At 312, optional treatments such as anti-odor or anti-fungus treatments may be executed to desired portions of the insole by spraying, for example.

At 314, the insole may be packaged optionally pair-wise for shipping and storing. In some alternative embodiments, the insole may be inserted in a shoe for shipping, storing and/or retail purposes.

At 316, the insole may be heated and shaped according to a user's foot to provide support and correct foot posture. The insole hardens upon cooling back but retains its modified shape. The insole may be cut to better fit the target footwear and provide comfort. The preform turns into an actual customized insole.

Generally, various embodiments of the insole according to the present invention may be sold separately or together with a matching shoe, for example. Even in the latter case the insole is preferably removable.

The method execution is ended at 318. Item 316 may be re-executed for correcting the shape, for example, which is indicated by the broken loop-back arrow in the figure. The mutual ordering of method items described above may be altered as being obvious to a skilled person. For example, the execution order of items 310 and 312 may be reversed depending on each particular embodiment, which is emphasized by a bi-directional arrow in the figure. Accordingly, some method items may be divided into further sub-items or be aggregated. A number of new items may be included in the method.

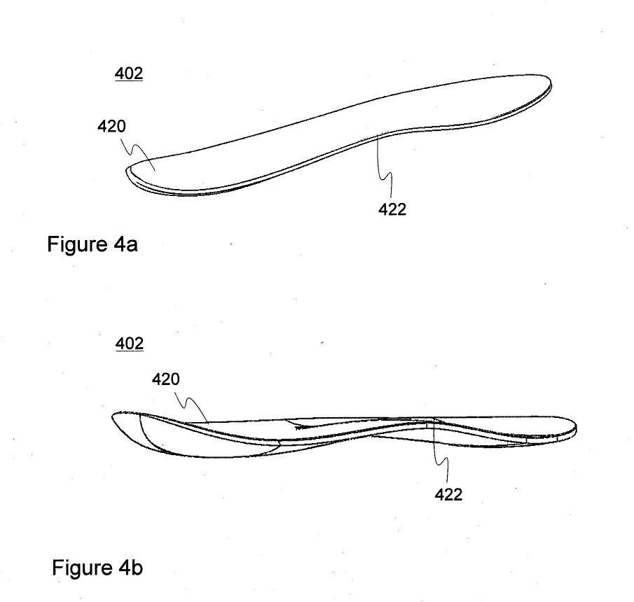

FIGS. 4a and 4b illustrate an embodiment of an insole 402 generally discussed herein after heating and shaping, i.e. customization in view of a user's foot, from two different angles. It is clearly visible in the figures how e.g. the heel 420 and plantar arch 422 areas have been elevated to support the foot and maintain correct posture by shaping the underlying heat-sensitive support element accordingly.

The previously presented considerations concerning the various embodiments of the insole and the heat-sensitive support element thereof may be applied to the embodiments of the method mutatis mutandis, and vice versa, as being appreciated by a skilled person.

The scope of the present invention is determined by the attached claims together with the equivalents thereof. A person skilled in the art will appreciate the fact that the explicitly disclosed embodiments were constructed for illustrative purposes only, and the scope will cover further embodiments and equivalents that best suit each particular use case of the invention. For example, in some occasions the insole could include thermoset material instead of or in addition to thermoplastic material. The insole portion comprising thermoset material could be shaped prior to heating so that it is maintained in the modified shape while reaching a predetermined hardening temperature and then retains the newly shaped form afterwards. Further, some embodiments of the present invention could be tailored as to the materials, shapes, dimensions, etc. for use with animal feet instead of human users.

1. An insole for use with footwear, comprising:
a body having one or more material layers and comprising at least one heat-sensitive support element comprising thermoplastic material, the heat-sensitive support element is embedded in or joined with the body to enable shaping at least part of the insole when heated and hardening by cooling, wherein the heat-sensitive support element comprises a plurality of hollows facing a direction substantially opposite a predetermined top side of the insole intended to receive a foot of a user.

2. The insole according to claim 1, further comprising:
a top layer including fabric material intended to receive the foot of the user.

3. The insole according to claim 1, further comprising:
a bottom layer beneath the heat-sensitive support element intended to contact the footwear.

4. The insole according to claim 1, wherein the body further comprises at least one material selected from the group consisting of: foam, silicon-based foam, EVA (Ethylene Vinyl Acetate), PU (Polyurethane), PE (Polyethylene), and polyester.

5. The insole according to claim 1, wherein the heat-sensitive support element comprises at least one material selected from the group consisting of: ABS (acrylonitrile butadiene styrene), PVC (polyvinyl chloride), A-PET (Amorphous polyester terephthalate), and PETG (polyethylene terephthalate Glycol).

6. The insole according to claim 1, wherein the plurality of hollows is located, at least in relation to the longitudinal axis and optionally to the transverse axis, in the central portion of the heat-sensitive support element.

7. The insole according to claim 1, wherein the insole comprises gel material.

8. The insole according to claim 1, wherein the plurality of hollows is substantially configured in a cellular or matrix pattern.

9. The insole according to claim 1, further comprising:
at least one functional element selected from the group consisting of: a cushioning element, moisture-permeable element, moisture-repellent element, moisture absorbing element, moisture-controlling element, anti-bacteria element, anti-corn element, anti-fungus element, barrier element, odor-free element, arch support element, heel cup, stitching, washable element, and anti-slippery element.

10. The insole according to claim 1, wherein the heat-sensitive support element has an uneven thickness, and wherein the plurality of hollows is optionally located in one or more areas of greater thickness.

11. The insole according to claim 1, wherein the heat-sensitive support element has an uneven thickness and a portion thereof configured to support a plantar arch area of the foot of the user substantially belongs to the portion with the greatest thickness.

12. The insole according to claim 1, wherein a maximum or average thickness of the heat-sensitive support element is substantially equal to or less than 1.5 mm.

13. The insole according to claim 1, wherein a maximum or average thickness of the heat-sensitive support element is substantially equal to or less than 1.0 mm.

14. The insole according to claim 1, wherein a maximum or average thickness of the heat-sensitive support element is substantially equal to or less than 0.5 mm.

15. The insole according to claim 1, wherein a depth of the plurality of hollows is substantially equal to or greater than 20% of a maximum or average thickness of the heat-sensitive support element.

16. The insole according to claim 1, wherein a depth of the plurality of hollows is substantially equal to or greater than 40% of a maximum or average thickness of the heat-sensitive support element.

17. The insole according to claim 1, wherein a depth of the plurality of hollows is substantially equal to or greater than 50% of the maximum or average thickness of the heat-sensitive support element.

18. A method for manufacturing an insole, the method comprising:
obtaining at least one heat-sensitive support element comprising thermoplastic material and being configured with a plurality of hollows on a predetermined bottom side of the element; and
providing an insole body comprising one or more material layers with the heat-sensitive support element to enable shaping at least part of the insole when heated and hardening by cooling.

19. The method according to claim 18, wherein a plurality of elements have been integrated by applying at least one technique selected from the group consisting of:
molding, laminating, gluing, stitching, and the use of a number of fastening elements.

20. The method according to claim 19, wherein the plurality of elements includes the body and the heat-sensitive support element.

21. The method according to claim 18, wherein the heat-sensitive support element and at least a portion of the plurality of hollows are formed utilizing molding, optionally injection molding.

22. The method according to claim 14, wherein at least a portion of the plurality of hollows are formed by machining the support material.

23. A heat-sensitive support element for an insole of footwear, said support element comprising:
thermoplastic material to enable shaping at least part of the insole when heated and hardening by cooling; and
a plurality of hollows on a predetermined bottom side of the element configured to substantially face, when in use, the insole bottom.
